(19) United States
(12) Patent Application Publication
(10) Pub. No.: US 2024/0379996 A1
(43) Pub. Date: Nov. 14, 2024

(54) HIGH-POWER, OXIDE-BASED SOLID-STATE BATTERY WITH THIN SILICON FILM AND IN-SITU GEL POLYMER ELECTROLYTE

(71) Applicant: GM GLOBAL TECHNOLOGY OPERATIONS LLC, Detroit, MI (US)

(72) Inventors: Qili SU, Shanghai (CN); Zhe Li, Shanghai (CN); Yong Lu, Shanghai (CN); Haijing Liu, Shanghai (CN)

(21) Appl. No.: 18/446,219

(22) Filed: Aug. 8, 2023

(30) Foreign Application Priority Data
May 8, 2023 (CN) 202310512705.0

(51) Int. Cl. H01M 10/0562; H01M 4/505; H01M 4/58; H01M 4/66; H01M 50/491

(52) U.S. Cl. CPC H01M 10/0562; H01M 4/505; H01M 4/5825; H01M 4/662; H01M 50/491; H01M 2300/0071

(57) ABSTRACT

An oxide-based solid-state battery cell includes a cathode electrode comprising a cathode current collector. A cathode active layer is arranged adjacent to the cathode current collector and comprising cathode active material that exchanges lithium ions and a solid oxide electrolyte and an in-situ polymerization gel. A separator layer comprises a solid oxide electrolyte, a porous layer, and the in-situ polymerization gel. An anode electrode comprises an anode current collector, a silicon film, and the in-situ polymerization gel.

### CROSS-REFERENCE TO RELATED APPLICATIONS

This application claims the benefit of Chinese Patent Application No. 202310512705.0, filed on May 8, 2023. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to batteries, and more particularly to high-power, oxide-based solid-state batteries with in-situ gel polymer electrolyte.

Low voltage automotive battery systems such as 12V battery systems can be used for starting vehicles, supporting stop/start functionality, and/or supplying vehicle accessory loads or other vehicle systems. Low voltage automotive battery systems can also be used to support vehicle accessory loads in electric vehicles (EVs) such as battery electric vehicles, hybrid vehicles and/or fuel cell vehicles.

During cold starting or stop/start events, the battery system supplies current to a starter to crank the engine. When the vehicle is cold started, the battery needs to supply sufficient cranking power. In some applications, the battery system may continue to supply power for various electrical systems of the vehicle after the engine is started. An alternator or regeneration recharges the battery system.

### SUMMARY

An oxide-based solid-state battery cell includes a cathode electrode comprising a cathode current collector. A cathode active layer is arranged adjacent to the cathode current collector and comprising cathode active material that exchanges lithium ions and a solid oxide electrolyte and an in-situ polymerization gel. A separator layer comprises a solid oxide electrolyte, a porous layer, and the in-situ polymerization gel. An anode electrode comprises an anode current collector, a silicon film, and the in-situ polymerization gel.

In other features, the solid oxide electrolyte comprises Li₁₊ₓAlₓTi₂₋ₓ(PO₄)₃ where 0.3≤x≤0.5. The silicon film comprises pure silicon. The silicon film comprises columnar silicon. The anode current collector is made of a material selected from a group consisting of stainless steel, nickel, iron, titanium, copper, and alloys thereof. The in-situ polymerization gel comprises a liquid electrolyte, a polymer monomer, and an initiator. The liquid electrolyte comprises a lithium salt, a solvent, and an additive. The lithium salt comprises LiPF6, the solvent comprises carbonate ester, and the additive comprises fluoroethylene carbonate (FEC).

In other features, the polymer monomer is selected from a group consisting of ethylene oxide (EO), vinylidene fluoride (VDF), VDF-hexafluoropropylene (VDF-HFP), propylene-oxide (PO), acrylonitrile (AN), poly(methacrylic acid-niclosamide) (PMAN), glycidyl methacrylate (GMA) and their corresponding oligomers and co-polymers. The initiator is selected from a group consisting of peroxide, an azo compound, and combinations thereof.

In other features, the cathode active layer comprises lithium manganese iron phosphate (LMFP) in a range from 76 wt % to 20 wt %, lithium ion manganese oxide (LMO) in a range from 20 wt % to 76 wt %, Li₁₊ₓAlₓTi₂₋ₓ(PO₄)₃ electrolyte, where 0.3≤x≤0.5, in a range from 1 wt % to 10 wt %, carbon in a range from 1 wt % to 5 wt %, carbon nanotubes (CNT) in a range from 0 wt % to 0.5 wt %, and polyvinylidene difluoride (PVDF) in a range from 1 wt % to 10 wt %.

In other features, the cathode active layer comprises lithium manganese iron phosphate (LMFP) in a range from 40 wt % to 48 wt %, lithium ion manganese oxide (LMO) in a range from 40 wt % to 48 wt %, Li₁₊ₓAlₓTi₂₋ₓ(PO₄)₃ electrolyte, where 0.3≤x≤0.5, in a range from 4 wt % to 6 wt %, carbon in a range from 2 wt % to 4 wt %, and polyvinylidene difluoride (PVDF) in a range from 3 wt % to 5 wt %. An N:P ratio of the oxide-based solid-state battery cell is in a range from 1 to 2.5.

In other features, the porous layer comprises polymer having a porosity in a range from 35% to 55%.

An oxide-based solid-state battery cell comprises a cathode electrode comprising a cathode current collector, a cathode active layer arranged adjacent to the cathode current collector and comprising a cathode active material that exchanges lithium ions, a solid oxide electrolyte comprising Li₁₊ₓAlₓTi₂₋ₓ(PO₄)₃ where 0.3≤x≤0.5, and an in-situ polymerization gel; a separator layer comprising the solid oxide electrolyte, a porous layer having a porosity in a range from 35% to 55%, and the in-situ polymerization gel; and an anode electrode comprising an anode current collector, a silicon layer arranged on the anode current collector, and the in-situ polymerization gel.

In other features, the silicon layer comprises columnar silicon. The in-situ polymerization gel comprises a liquid electrolyte, a polymer, and an initiator. The liquid electrolyte comprises a lithium salt, a solvent, and an additive, the polymer monomer is selected from a group consisting of ethylene oxide (EO), vinylidene fluoride (VDF), VDF-hexafluoropropylene (VDF-HFP), propylene-oxide (PO), acrylonitrile (AN), poly(methacrylic acid-niclosamide) (PMAN), glycidyl methacrylate (GMA) and their corresponding oligomers and co-polymers, and the initiator is selected from a group consisting of peroxide and an azo compound.

In other features, the lithium salt comprises LiPF₆, the solvent comprises carbonate ester, and the additive comprises fluoroethylene carbonate (FEC). The cathode active layer comprises lithium manganese iron phosphate (LMFP) in a range from 76 wt % to 20 wt %, lithium ion manganese oxide (LMO) in a range from 20 wt % to 76 wt %, Li₁₊ₓAlₓTi₂₋ₓ(PO₄)₃ electrolyte, where 0.3≤x≤0.5, in a range from 1 wt % to 10 wt %, Super P in a range from 1 wt % to 5 wt %, carbon nanotubes (CNT) in a range from 0 wt % to 0.5 wt %, and polyvinylidene difluoride (PVDF) in a range from 1 wt % to 10 wt %.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a simplified side cross-sectional view of a battery cell;

FIG. 2 is side cross-sectional view of an oxide-based, solid-state battery cell according to the present disclosure;

FIG. 3 is a graph illustrating capacity as a function of cycles for a half coin cell according to the present disclosure;

FIG. 4 is a graph illustrating capacity retention as a function of cycles for a full coin cell according to the present disclosure;

FIG. 5 is a graph illustrating capacity retention as a function of cycles according to the present disclosure;

FIG. 6A is a graph illustrating capacity retention as a function of cycles according to the present disclosure;

FIG. 6B is a graph illustrating voltage as a function of capacity retention and different discharge rates according to the present disclosure;

FIG. 7 is a graph illustrating voltage as a function of cycles during cold cranking according to the present disclosure;

FIG. 8 is a graph illustrating capacity retention percentage as a function of cycles according to the present disclosure.

In the drawings, reference numbers may be reused to identify similar and/or identical elements.

### DETAILED DESCRIPTION

While the present disclosure describes high-power, oxide-based solid-state batteries used in vehicle applications, the battery cells can be used in stationary or other types of applications.

Oxide-based, all-solid-state batteries include a plurality of cathode electrodes, anode electrodes and separator layers arranged in a predetermined sequence in an enclosure of a battery cell. The cathode electrodes include a cathode current collector and a cathode active layer arranged on one or both sides of the cathode current collector. The cathode active layer includes cathode active material (such as lithium ion manganese oxide (LMO)) and a solid oxide electrolyte (such as lithium lanthanum zirconium oxide (LLZO)).

The separator layers include an oxide electrolyte (such as LLZO). The anode electrodes include an anode current collector and an anode active layer arranged on one or both sides of the anode current collector. The anode active layer includes anode active material (such as silicon particles) and oxide electrolyte (such as LLZO).

The oxide-based, all-solid-state batteries using this design have high electrochemical stability, wide working temperature, high temperature stability, and the potential for high energy. However, these oxide-based, all-solid-state batteries have poor solid-to-solid contact with limited lithium-ion conduction pathways between the active material and the solid electrolyte.

A high-power, oxide-based, solid-state battery according to the present disclosure includes an anode electrode including a silicon film to provide short lithium-ion/electronic conduction paths and in-situ formed gel polymer electrolyte to enhance solid-to-solid contact. The solid-state battery delivers high cold-start voltage at −18° C. that meets engineering requirements and a good 10 C rate capability (85% at 1 C discharge capacity) at 25° C. In addition, the high-power, oxide-based solid-state battery demonstrates a capacity retention of 97.8% over 100 cycles. The solid-state design paves the way for the use of silicon-based anodes in automotive high-power applications.

Referring now to FIG. 1, an oxide-based, solid-state battery cell 10 includes cathode electrodes 20, anode electrodes 40, and separator layers 32 arranged in a predetermined sequence in an enclosure 50. The cathode electrodes 20-1, 20-2, . . . , and 20-C (where C is an integer greater than one) include cathode active layers 24 arranged on one or both sides of cathode current collectors 26. The anode electrodes 40-1, 40-2, . . . , and 40-A (where A is an integer greater than one) include anode active layers 42 arranged on one or both sides of the anode current collectors 46.

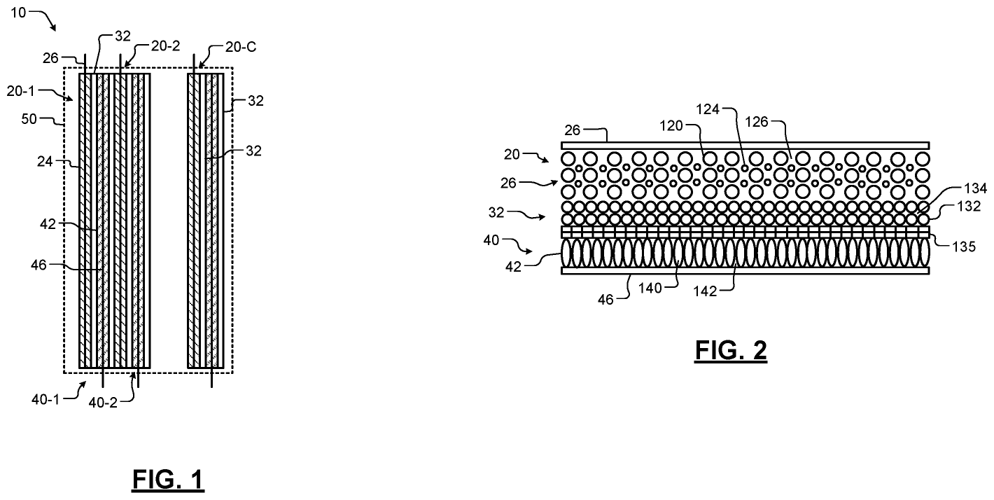

Referring now to FIG. 2, the cathode electrodes 20 include the cathode current collector 26, cathode active material 120, solid electrolyte 124, and an in-situ polymerization gel 126 arranged on one or both sides of the cathode current collector 26.

The separator layer 32 includes solid electrolyte 132, the in-situ polymerization gel 134 and a porous layer 135. In some examples, the solid electrolyte 132 includes lithium aluminum titanium phosphate (LATP) such as Li₁₊ₓAlₓTi₂₋ₓ(PO₄)₃ where 0.3≤x≤0.5. In some examples, the LATP solid electrolyte is used to boost lithium ion conduction. In some examples, the porous layer 135 is made of polymer and has a porosity in a range from 35% to 55%.

The anode electrode 40 includes the anode current collector 46, anode active material 140, and the in-situ polymerization gel 142 arranged on one or both sides of the anode current collector 46. In some examples, the anode active material includes silicon film. In some examples, the silicon film includes pure silicon (100%) and does not include binder or carbon. In some examples, the silicon film has a specific capacity in a range from 2500 to 3800 mAh/g (0.1 C).

In some examples, the silicon film has a first cycle efficiency greater than 92% (0 V to 1.5V), low loading (less than 3 mAh/cm²), a thickness less than 5 μm, and porosity in a range from greater than 0% to less than or equal to 20%. In some examples, the silicon film comprises columnar silicon having a specific capacity of 3650 mAh/cm², a first cycle efficiency greater than 95%, loading of 2 mAh/cm², a thickness of 3 μm, and/or a porosity of 20%.

In some examples, the anode current collector 46 has a thickness in a range from 4 μm to 30 μm. In some examples, the anode current collector 46 is made of a material selected from a group consisting of stainless steel, nickel, iron, titanium, copper, and their alloys and/or other conductive materials. The surface morphology can be flat or rough. In some examples, copper foil having a thickness of 14 μm and a rough surface is used.

In some examples, the in-situ polymerization gel includes a liquid electrolyte, a polymer, and an initiator. In some examples, the liquid electrolyte comprises greater than 90 wt % of the in-situ polymerization gel. In some examples, the liquid electrolyte includes a lithium salt, a solvent, and one or more additives. In some examples, the lithium salt includes LIPF₆ having a concentration of 0.8 to 1.2 mol/L. In some examples, the solvent comprises carbonate ester. In some examples, the additives comprise fluoroethylene carbonate (FEC). In some examples, the polymerization gel comprises 1 M/L LiPF₆ in ethylene carbonate (EC)/dimethyl carbonate (DMC)/ethyl methyl carbonate (EMC)/FEC (e.g., 3:3:3:1 volume ratio) (e.g., 96.8 wt % of the in-situ polymerization gel).

In some examples, the polymer comprises oligomers such as ethylene oxide (EO), vinylidene fluoride (VDF), VDF-hexafluoropropylene (VDF-HFP), propylene-oxide (PO), acrylonitrile (AN), poly(methacrylic acid-niclosamide) (PMAN), glycidyl methacrylate (GMA), and their corresponding oligomers and co-polymers. In some examples, the polymer comprises less than 5 wt % of the in-situ polymerization gel. In some examples, the polymer comprises a mixture of EO and GMA (e.g., 3.2 wt % of the in-situ polymerization gel). In some examples, the initiator is selected from a group consisting of peroxide, azo compounds, and combinations thereof. In some examples, the initiator comprises less than 1 wt % of the in-situ polymerization gel.

In some examples, the cathode active material comprises LiMnₓFe₁₋ₓPO₄ (LMFP, 0.6≤x≤0.75), has a D50 diameter (or median particle diameter)≤12 um, 130-150 mAh/g (1 C), a Brunauer, Emmett and Teller (BET) surface area of 12-30 m²/g, and/or a carbon coating of 1% to 4%. In other examples, the cathode active material comprises LiMn₂O₄ (LMO), has a D50 diameter less than 12 um, a D95 diameter less than 20 μm, a specific capacity of 95-105 mAh/g (1 C), and/or a BET surface area of 0.3-1.2 m²/g.

In some examples, the cathode composition comprises lithium manganese iron phosphate (LMFP), lithium ion manganese oxide (LMO), LATP, carbon such as Super P (SP), carbon nanotubes (CNT), and/or polyvinylidene difluoride (PVDF). In some examples, cathode composition comprises LMFP (in a range from 76 wt % to 20 wt %), LMO (in a range from 20 wt % to 76 wt %), LATP (in a range from 1 wt % to 10 wt %), SP (in a range from 1 wt % to 5 wt %), CNT (in a range from 0 wt % to 0.5 wt %), and PVDF (in a range from 1 wt % to 5 wt %). In some examples, the viscosity is in a range from 1500 to 2500 mPas (20 s⁻¹ at room temperature). In some examples, the cathode has a capacity loading of 1.05+/−0.1 mAh/cm² for a 1 side coating (1 C at room temperature). In some examples, the cathode has a pressing density in a range from 2.0 to 2.6 g/cm³ and a porosity of 25% to 35%. In some examples, the cathode electrode has an electrical conductivity less than 2 Ωcm and moisture content less than 600 ppm.

In some examples, the LMFP in the cathode comprises LiMn_{0.7}Fe_{0.3}PO₄, having a D50 diameter of 8.9 um, a specific capacity of 147 mAh/g (1 C), and/or a BET 14.8 m²/g. In some examples, the LMO in the cathode comprises LiMn₂O₄, having a D50 diameter of 8.4 um, a specific capacity 102 mAh/g (1 C), and/or a BET of 0.5 m²/g.

In some examples, the cathode composition includes LMFP (40 wt % to 48 wt %), LMO (40 wt % to 48 wt %), LATP (4 wt % to 6 wt %), SP (2 wt % to 4 wt %), and PVDF (3 wt % to 5 wt %). In some examples, the cathode composition comprises LMFP/LMO/LATP/SP/PVDF at 44/44/5/3/4 wt %, respectively. In some examples, one-side capacity loading is 1.05 mAh/cm² (for a one side coating and 1 C at room temperature) and a pressing density of 2.2 g/cm³.

In some examples, the separator layer comprise the LATP layer, the porous layer 135, and the in-situ polymerization gel. In some examples, the LATP layer has a thickness in a range from 2 to 4 um (e.g., 3 μm) and a porosity in a range from 20% to 40% (e.g., 20%). In some examples, the porous layer 135 comprises a polyolefin-based separator (e.g., polyacetylene, polypropylene (PP)) having a porosity in a range from 35% to 55% (e.g., 45%) and a thickness in a range from 6 to 12 um. (e.g., 9 μm). In some examples, an N:P ratio of the battery is in a range from 1 to 2.5 (e.g., 1.9).

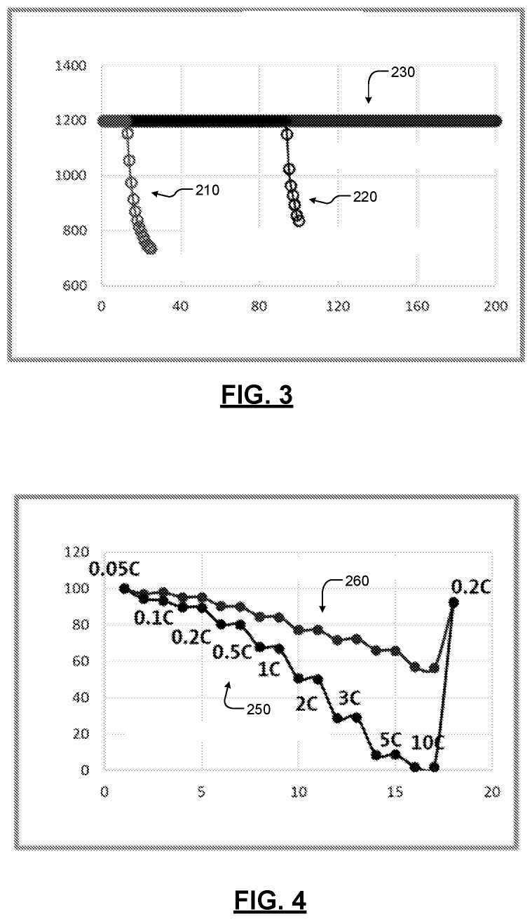

Referring now to FIGS. 3 and 4, cycling performance is shown. In FIG. 3, capacity (mAh/g) is shown as a function of cycles during C/3 cycling for half coin cells with anode electrodes including silicon particles with capacity loading of ˜5 mAh/cm² (shown at 210), silicon film with capacity loading of ˜5 mAh/cm² (shown at 220), and silicon film with capacity loading of ˜2 mAh/cm² (shown at 230).

In FIG. 4, capacity retention percentage is shown for full coin cells with anode electrodes including silicon film with capacity loading of ˜5 mAh/cm² (shown at 250), and silicon film with capacity loading of ˜2 mAh/cm² (shown at 260). The cells with silicon film with the capacity loading of ˜5 mAh/cm² show good cycling performance due to the stable silicon film/electrolyte interface. The cells with silicon film capacity loading of ˜2 mAh/cm² show improved cycling performance relative to higher loading at ˜5 mAh/cm². As can be appreciated, higher power capability corresponds to reduced electrode thickness.

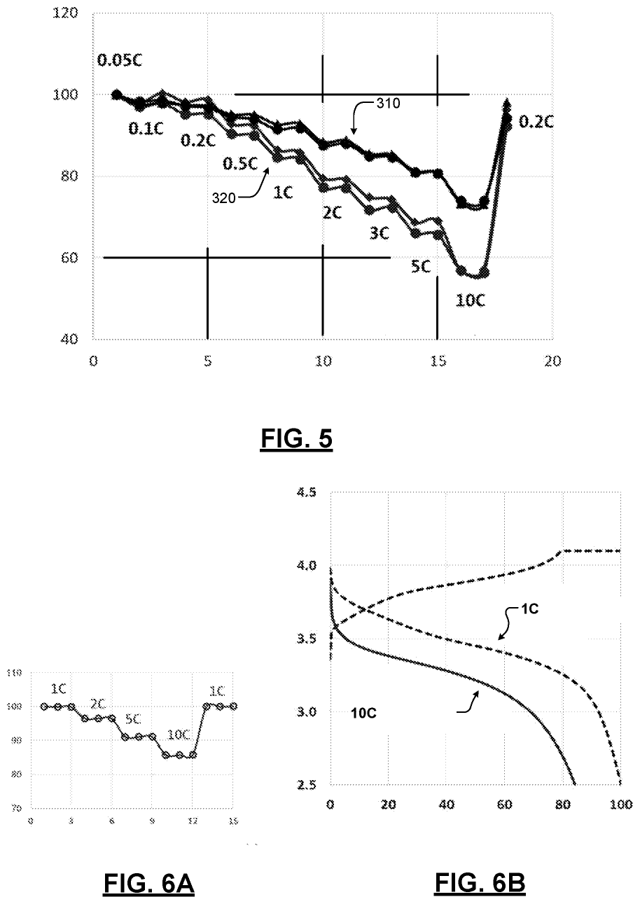

Referring now to FIG. 5, capacity retention percentage is shown as a function of cycles for cells with gel electrolyte at 310 and liquid electrolyte at 320. As can be seen, the cells with gel electrolyte at 310 have improved power capability due to the affinity properties relative to the silicon film.

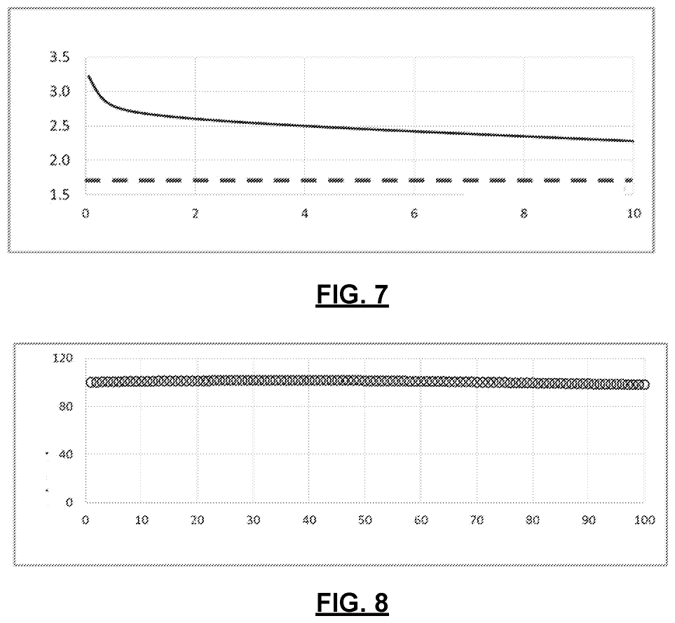

Referring now to FIG. 6A to 8, performance of the battery cell in a pouch configuration is shown. In FIG. 6A, capacity retention percentage is shown as a function of cycles for a pouch cell during discharge at 1 C, 2 C, 5 C, and 10 C. Capacity retention is greater than 85% at 10 C discharge rate. Capacity is near 100% at 1 C discharge rate. In FIG. 6B, voltage is shown as a function of capacity retention percentage.

In FIG. 7, voltage is shown as a function of cycles during cold cranking at −18° C., 80 SOC, and a 10 C pulse. The battery cell has excellent cranking capability that is above 1.8V at 10 C pulse for more than 10 s. In FIG. 8, capacity retention is shown at room temperature 25° C. at 1 C for 100 cycles. The battery cell has excellent cycling capability greater than 97.8% after 100 cycles.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. An oxide-based solid-state battery cell comprising:
a cathode electrode comprising:
a cathode current collector;
a cathode active layer arranged adjacent to the cathode current collector and comprising cathode active material that exchanges lithium ions and a solid oxide electrolyte; and
an in-situ polymerization gel;
a separator layer comprising a solid oxide electrolyte, a porous layer, and the in-situ polymerization gel; and
an anode electrode comprising an anode current collector, a silicon film, and the in-situ polymerization gel.

2. The oxide-based solid-state battery cell of claim 1, wherein the solid oxide electrolyte comprises Li₁₊ₓAlₓTi₂₋ₓ(PO₄)₃ where 0.3≤x≤0.5.

3. The oxide-based solid-state battery cell of claim 1, wherein the silicon film comprises pure silicon.

4. The oxide-based solid-state battery cell of claim 1, wherein the silicon film comprises columnar silicon.

5. The oxide-based solid-state battery cell of claim 1, wherein the anode current collector is made of a material selected from a group consisting of stainless steel, nickel, iron, titanium, copper, and alloys thereof.

6. The oxide-based solid-state battery cell of claim 1, wherein the in-situ polymerization gel comprises a liquid electrolyte, a polymer monomer, and an initiator.

7. The oxide-based solid-state battery cell of claim 6, wherein the liquid electrolyte comprises a lithium salt, a solvent, and an additive.

8. The oxide-based solid-state battery cell of claim 7, wherein:
the lithium salt comprises LiPF₆,
the solvent comprises carbonate ester, and
the additive comprises fluoroethylene carbonate (FEC).

9. The oxide-based solid-state battery cell of claim 6, wherein the polymer monomer is selected from a group consisting of ethylene oxide (EO), vinylidene fluoride (VDF), VDF-hexafluoropropylene (VDF-HFP), propylene-oxide (PO), acrylonitrile (AN), poly(methacrylic acid-niclosamide) (PMAN), glycidyl methacrylate (GMA) and their corresponding oligomers and co-polymers.

10. The oxide-based solid-state battery cell of claim 6, wherein the initiator is selected from a group consisting of peroxide, an azo compound, and combinations thereof.

11. The oxide-based solid-state battery cell of claim 1, wherein the cathode active layer comprises:
lithium manganese iron phosphate (LMFP) in a range from 76 wt % to 20 wt %,
lithium ion manganese oxide (LMO) in a range from 20 wt % to 76 wt %,
Li₁₊ₓAlₓTi₂₋ₓ(PO₄)₃ electrolyte, where 0.3≤x≤0.5, in a range from 1 wt % to 10 wt %,
carbon in a range from 1 wt % to 5 wt %,
carbon nanotubes (CNT) in a range from 0 wt % to 0.5 wt %, and
polyvinylidene difluoride (PVDF) in a range from 1 wt % to 10 wt %.

12. The oxide-based solid-state battery cell of claim 1, wherein the cathode active layer comprises:
lithium manganese iron phosphate (LMFP) in a range from 40 wt % to 48 wt %,
lithium ion manganese oxide (LMO) in a range from 40 wt % to 48 wt %,
Li₁₊ₓAlₓTi₂₋ₓ(PO₄)₃ electrolyte, where 0.3≤x≤0.5, in a range from 4 wt % to 6 wt %,
carbon in a range from 2 wt % to 4 wt %, and
polyvinylidene difluoride (PVDF) in a range from 3 wt % to 5 wt %.

13. The oxide-based solid-state battery cell of claim 1, wherein an N:P ratio of the oxide-based solid-state battery cell is in a range from 1 to 2.5.

14. The oxide-based solid-state battery cell of claim 1, wherein the porous layer comprises polymer having a porosity in a range from 35% to 55%.

15. An oxide-based solid-state battery cell comprising:
a cathode electrode comprising a cathode current collector, a cathode active layer arranged adjacent to the cathode current collector and comprising a cathode active material that exchanges lithium ions, a solid oxide electrolyte comprising Li₁₊ₓAlₓTi₂₋ₓ(PO₄)₃ where 0.3≤x≤0.5, and an in-situ polymerization gel;
a separator layer comprising the solid oxide electrolyte, a porous layer having a porosity in a range from 35% to 55%, and the in-situ polymerization gel; and
an anode electrode comprising an anode current collector, a silicon layer arranged on the anode current collector, and the in-situ polymerization gel.

16. The oxide-based solid-state battery cell of claim 15, wherein the silicon layer comprises columnar silicon.

17. The oxide-based solid-state battery cell of claim 15, wherein the in-situ polymerization gel comprises a liquid electrolyte, a polymer, and an initiator.

18. The oxide-based solid-state battery cell of claim 17, wherein:
the liquid electrolyte comprises a lithium salt, a solvent, and an additive,
the polymer monomer is selected from a group consisting of ethylene oxide (EO), vinylidene fluoride (VDF), VDF-hexafluoropropylene (VDF-HFP), propylene-oxide (PO), acrylonitrile (AN), poly(methacrylic acid-niclosamide) (PMAN), glycidyl methacrylate (GMA) and their corresponding oligomers and co-polymers, and
the initiator is selected from a group consisting of peroxide and an azo compound.

19. The oxide-based solid-state battery cell of claim 18, wherein:
the lithium salt comprises LiPF₆,
the solvent comprises carbonate ester, and
the additive comprises fluoroethylene carbonate (FEC).

20. The oxide-based solid-state battery cell of claim 15, wherein the cathode active layer comprises:
lithium manganese iron phosphate (LMFP) in a range from 76 wt % to 20 wt %,
lithium ion manganese oxide (LMO) in a range from 20 wt % to 76 wt %,
Li₁₊ₓAlₓTi₂₋ₓ(PO₄)₃ electrolyte, where 0.3≤x≤0.5, in a range from 1 wt % to 10 wt %,
Super P in a range from 1 wt % to 5 wt %,
carbon nanotubes (CNT) in a range from 0 wt % to 0.5 wt %, and
polyvinylidene difluoride (PVDF) in a range from 1 wt % to 10 wt %.
